(19) United States
(12) Patent Application Publication
(10) Pub. No.: US 2012/0315950 A1
(43) Pub. Date: Dec. 13, 2012

(54) DUAL MODE MOBILE COMMUNICATION TERMINAL

(75) Inventor: XIAO-DONG WANG, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/177,966

(22) Filed: Jul. 7, 2011

(30) Foreign Application Priority Data
Jun. 13, 2011 (CN) 201110157284.1

(51) Int. Cl. H04W 88/06

(52) U.S. Cl. 455/552.1

(57) ABSTRACT

A dual mode mobile communication terminal includes a GSM antenna, a GSM radio frequency (RF) circuit, a baseband circuit, a CDMA antenna, and a CDMA RF circuit. The GSM antenna and the CDMA antenna receive and transmit GSM signals and CDMA signals respectively. The baseband circuit processes the GSM signals and the CDMA signals, and generates corresponding signals. The CDMA RF circuit includes a low noise amplifier (LNA). The baseband circuit controls the LNA according to the transmission power levels of the GSM signal to lower the strength of the GSM signal in the LNA, to reduce and prevent mutual or other interference between the GSM signal and the CDMA signal so as to provide high-quality CDMA signals.

### BACKGROUND

1. Technical Field

The disclosure generally relates to wireless communication technology, and more particularly to a dual mode mobile communication terminal.

2. Description of the Related Art

Dual mode mobile terminals, such as dual mode mobile phones, often employ two different network standards, such as the Global System for Mobile Communications (GSM) network and Code Division Multiple Access (CDMA) network. A CDMA antenna is employed in the dual mode mobile terminal to receive and transmit CDMA signals, and a GSM antenna is employed in the dual mode mobile terminal to receive and transmit GSM signals.

However, when the operating frequency, such as 800 MHz of the CDMA signal is substantially adjacent to the operating frequency (e.g., 900 MHz) of the GSM signal from the GSM antenna, the CDMA signal and the GSM signal may cross or interfere with each other, reducing reception performance, sensitivity and clarity of the dual mode mobile communication terminal.

Therefore, there is room for improvement within the art.

### BRIEF DESCRIPTION OF THE DRAWINGS

Many aspects of a dual mode mobile communication terminal can be better understood with reference to the following drawings. The components in the drawings are not necessarily drawn to scale, the emphasis instead being placed upon clearly illustrating the principles of the dual mode mobile communication terminal. Moreover, in the drawings, like reference numerals designate corresponding parts throughout the several views. Wherever possible, the same reference numbers are used throughout the drawings to refer to the same or like elements of an embodiment.

FIG. 1 is a block view of a dual mode mobile communication terminal, according to an embodiment of the disclosure.

FIG. 2 is a circuit view of the dual mode mobile communication terminal shown in FIG. 1 of the disclosure.

FIG. 3 is a circuit view of another embodiment of a dual mode mobile communication terminal.

### DETAILED DESCRIPTION

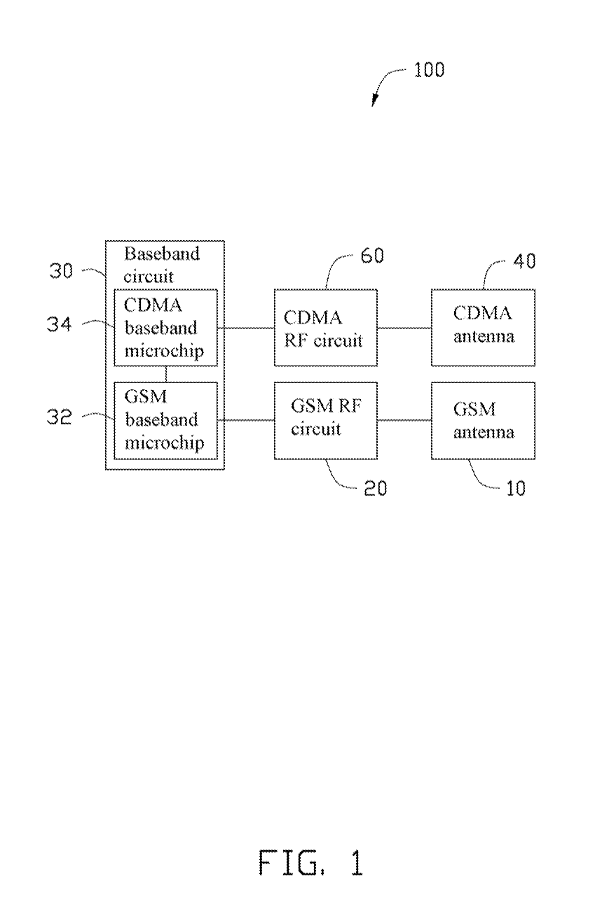

FIG. 1 is a block view of a dual mode mobile communication terminal 100, according to an embodiment of the disclosure. The dual mode mobile communication terminal 100 can be a dual mode mobile phone or other wireless communication devices. The dual mode mobile communication terminal 100 includes a Global System for Mobile Communications (GSM) antenna 10, a GSM radio frequency (RF) circuit 20, a baseband circuit 30, a Code Division Multiple Access (CDMA) antenna 40, and CDMA RF circuit 60.

The GSM antenna 10 is configured for receiving and transmitting GSM signals, the frequency band for which may be GSM900 MHz and GSM1800 MHz. The GSM RF circuit 20 is capable of processing the GSM signals. In this embodiment, the GSM RF circuit 20 is electrically connected to the GSM antenna 10. The GSM RF circuit 20 demodulates, filters and processes the GSM signals received from the GSM antenna 10. The GSM RF circuit 20 is further capable of amplifying and otherwise processing the GSM signals from the baseband circuit 30, and transmitting the processed GSM signals to the GSM antenna 10.

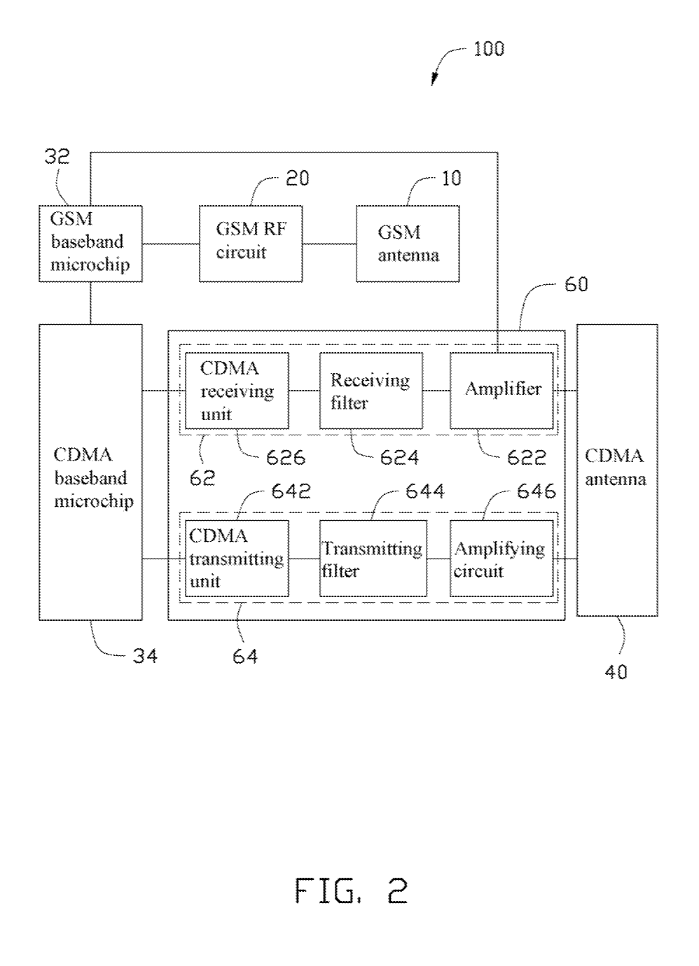

Further referring to FIG. 2, the baseband circuit 30 includes a GSM baseband microchip 32 and a CDMA microchip 34 in electronic communication with the GSM baseband microchip 32. In this embodiment, the GSM baseband microchip 32 is in electronic communication with the GSM RF circuit 20 and is capable of decoding and converting the GSM signals from the GSM RF circuit 20 into corresponding audio signals. The GSM baseband microchip 32 is further capable of coding, compiling or synthesizing all audio signals into corresponding baseband signals, for forwarding to the GSM RF circuit 20.

The CDMA baseband microchip 34 is in electronic communication with the CDMA RF circuit 60, and is capable of decoding and converting the CDMA signals from the CDMA RF circuit 60 into corresponding audio signals, and is further configured for coding, compiling or converting all audio signals into corresponding baseband signals, for forwarding to the CDMA RF circuit 60.

The CDMA antenna 40 is capable of receiving and transmitting CDMA signals, the frequency band for which may be CDMA800 MHz and CDMA850 MHz. In this embodiment, the high-power GSM signals transmitted by the GSM antenna 10 may be received by the CDMA antenna 40, resulting in the two types of signals interfering with each other, effecting the reception performance and sensitivity of the CDMA system of the dual mode mobile communication terminal 100.

In this embodiment, the CDMA RF circuit 60 is electrically connected to the baseband circuit 30 and the CDMA antenna 40. The CDMA RF circuit 60 includes a CDMA receiving circuit 62 and a CDMA transmitting circuit 64. The CDMA receiving circuit 62 includes an amplifier 622, a receiving filter 624, and a CDMA receiving unit 626. In this embodiment, the amplifier 622 can be a low noise amplifier (LNA) and is electrically connected to the CDMA antenna 40 and the GSM baseband microchip 32.

The amplifier 622 is capable of amplifying the CDMA signals captured by the CDMA antenna 40 and improving their signal to noise ratio (SNR) of the CDMA signals, boosting the CDMA performance while adding as little noise and distortion as possible. In this embodiment, the GSM baseband microchip 32 controls and enables the amplifier 622 to adjust and set the gain of the amplifier 622 according to different power levels in the transmission of the GSM signals, to further adjust the linearity of the amplifier 622 accordingly. For example, when the transmission power of the GSM signal increases, the GSM baseband microchip 32 controls the amplifier 622 to automatically reduce the gain of the amplifier 622 and improve its linearity and sensitivity, while reducing interference from noise and other extraneous CDMA signals, and improving the transmission performance of the CDMA system.

The receiving filter 624 is electrically connected to the amplifier 622 and is capable of suppressing and filtering out interference and noise to improve the quality of the CDMA signals. The CDMA receiving unit 626 can be a CDMA receiver and is electrically connected to the receiving filter 624 and to the CDMA baseband microchip 34. The CDMA receiving unit 626 separates the desired CDMA signals from all other signals, and demodulates the CDMA signal from the receiving filter 624 and then supplies the demodulated CDMA signal to the CDMA baseband microchip 34. The CDMA baseband microchip 34 converts the demodulated CDMA signal into corresponding audio signals.

The CDMA transmitting circuit 64 includes a CDMA transmitting unit 642, a transmitting filter 644, and an amplifying circuit 646. In this embodiment, the CDMA transmitting unit 642 can be a CDMA transmitter and is electrically connected to the CDMA baseband microchip 34. The CDMA transmitting unit 642 is configured for modulating the baseband signal from the CDMA baseband microchip 34 and transmitting the modulated baseband signal to the transmitting filter 644.

The transmitting filter 644 electrically connects the CDMA transmitting unit 642 and is capable of filtering out or suppressing unwanted interference and noise signals, background or otherwise, and producing only valid and desired CDMA signals. The amplifying circuit 646 can be a RF power amplifier and is electrically connected to the transmitting filter 644. The amplifying circuit 646 is capable of amplifying the CDMA signal, and transmitting its output to the CDMA antenna 40.

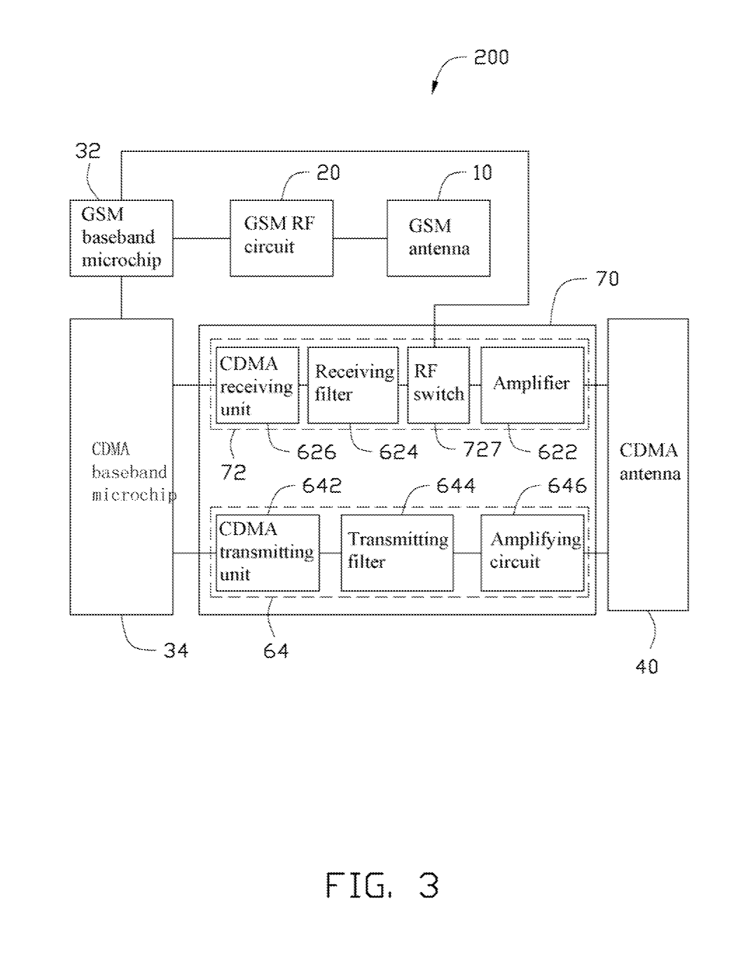

FIG. 3 is a block view of another embodiment of a dual mode mobile communication terminal 200. The dual mode mobile communication terminal 200 is similar to the dual mode mobile communication terminal 100 but includes a CDMA RF circuit 70. The CDMA RF circuit 70 includes a CDMA receiving circuit 72, and the CDMA receiving circuit 72 includes an amplifier 622, a receiving filter 624, and a CDMA receiving unit 626, which are substantially the same as those in the CDMA RF circuit 70 of the dual mode mobile communication terminal 100.

The CDMA receiving circuit 72 further includes a RF switch 727 electrically connected between the amplifier 622 and the receiving filter 624. The RF switch 727 is further electrically connected to the GSM baseband microchip 32 to compress non-linear signals from the amplifier 622 and to separate the GSM signal from the CDMA signal. In this embodiment, during the transmission timeslot of the GSM signals, the GSM baseband microchip 32 controls the RF switch 727 to disconnect a reception path for the CDMA signals and to compress the strength of the GSM signals which have reached the amplifier 622, so as to enhance the separation between the GSM signals and the CDMA signals. In addition, once outside the transmission timeslot of the GSM signals, the RF switch 727 is switched on to form and generate a reception path for the CDMA signals.

In summary, in the dual mode mobile communication terminal of the disclosure, the GSM baseband microchip 32 controls the amplifier 622 to accordingly adjust and set the gain based on the transmitting powers of the GSM signals, in order to further reduce and compress the GSM signals into the amplifier 622. Thus, the linearity and sensitivity of the amplifier 622 is improved to a preset level, the separation between the CDMA signals and the GSM signals is enhanced to reduce interference by the GSM signals with the CDMA signal, resulting in an improved transmission quality and performance of the CDMA signals.

In the present specification and claims the word “a” or “an” preceding an element does not exclude the presence of a plurality of such elements. Further, the word “comprising” does not exclude the presence of other elements or steps other than those listed.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A dual mode mobile communication terminal, comprising:
a GSM antenna receiving and transmitting a GSM signal;
a CDMA antenna receiving and transmitting a CDMA signal;
a GSM radio frequency (RF) circuit electrically connected to the GSM antenna;
a baseband circuit electrically connected to the GSM RF circuit, and the baseband circuit converting the GSM signal and the CDMA signal and providing corresponding baseband signal; and
a CDMA RF circuit electrically connected to the CDMA antenna and the baseband circuit, wherein the CDMA RF circuit comprises a low noise amplifier (LNA), the LNA is electrically connected between the CDMA antenna and the baseband circuit, and the baseband circuit controls the LNA according to transmitting powers of the GSM signal to lower the strength of the GSM signal in the LNA to prevent GSM signal interference to the CDMA signal.

2. The dual mode mobile communication terminal as claimed in claim 1, wherein the CDMA RF circuit further comprises a RF switch electrically connected between the LNA and the baseband circuit, the RF switch processes and compresses non-linear signals from the LNA and separate the GSM signal and the CDMA signal.

3. The dual mode mobile communication terminal as claimed in claim 2, wherein during transmission timeslot of the GSM signals, the baseband circuit controls the RF switch to disconnect a reception path of the CDMA signals and reduce the strength of the GSM signals entering into the LNA to reduce the interference between the GSM signal and the CDMA signal.

4. The dual mode mobile communication terminal as claimed in claim 2, wherein the baseband circuit comprises a GSM baseband microchip, the GSM baseband microchip is in electronic communication with the GSM RF circuit and the RF switch, the GSM baseband microchip decodes and converts the GSM signal from the GSM RF circuit into corresponding audio signal and further codes, compiles and synthesizes the audio signal into corresponding baseband signal for forwarding to the GSM RF circuit, and the GSM baseband microchip enables the LNA to adjust the gain of the LNA according to the transmitting powers of the GSM signals to further adjust the linearity of the LNA.

5. The dual mode mobile communication terminal as claimed in claim 4, wherein the baseband circuit further comprises a CDMA baseband microchip, the CDMA baseband microchip is in electronic communication with the GSM baseband microchip and the CDMA RF circuit, and the CDMA baseband microchip decodes and converts the CDMA signal from the CDMA RF circuit into corresponding audio signal, and further codes, compiles and converts the audio signals into corresponding baseband signals to the CDMA RF circuit.

6. The dual mode mobile communication terminal as claimed in claim 5, wherein the CDMA RF circuit further comprises a receiving filter electrically connected to the LNA, the receiving filter suppresses and filters interference and noise to improve the quality of the CDMA signal.

7. The dual mode mobile communication terminal as claimed in claim 6, wherein the CDMA RF circuit further comprises a CDMA receiving unit electrically connected to the receiving filter and the CDMA baseband microchip, the CDMA receiving unit separates the wanted CDMA signal from other signals, and demodulates the CDMA signal from the receiving filter, and transmits the demodulated CDMA signal to the CDMA baseband microchip to convert the demodulated CDMA signal into corresponding audio signal.

8. The dual mode mobile communication terminal as claimed in claim 5, wherein the CDMA RF circuit further comprises a CDMA transmitting circuit, and the CDMA transmitting circuit comprises a CDMA transmitting unit electrically connected to the CDMA baseband microchip, the CDMA transmitting unit is configured for modulating the baseband signal from the CDMA baseband microchip.

9. The dual mode mobile communication terminal as claimed in claim 8, wherein the CDMA transmitting circuit further comprises a transmitting filter electrically connected to the CDMA unit, the transmitting filter is capable of filtering out or suppressing unwanted interference and noise signals, background or otherwise, and producing valid and desired CDMA signals.

10. The dual mode mobile communication terminal as claimed in claim 9, wherein the CDMA transmitting circuit further comprises an amplifying circuit electrically connected to the transmitting filter and the CDMA antenna, the amplifying circuit is a RF power amplifier and is capable of amplifying the CDMA signal, and further transmitting its output CDMA signals to the CDMA antenna.

11. A dual mode mobile communication terminal, comprising:
a GSM antenna receiving and transmitting a GSM signal;
a CDMA antenna receiving and transmitting a CDMA signal;
a GSM radio frequency (RF) circuit electrically connected to the GSM antenna to receive and process the GSM signal;
a CDMA RF circuit electrically connected to the CDMA antenna to receive and process the CDMA signal; and
a baseband circuit electrically connected to the GSM RF circuit and the CDMA RF circuit, and the baseband circuit converting the GSM signal and the CDMA signal and generating and outputting baseband signal;
wherein the CDMA RF circuit comprising:
a low noise amplifier (LNA) electrically connected to the CDMA antenna; and
a RF switch electrically connected between the LNA and the baseband circuit,
wherein when the GSM antenna transmits the GSM signals of different transmitting powers, the baseband circuit controls and enables the LNA to reduce and prevent the GSM signal entering into the LNA according to the power levels in the transmission of the GSM signal, and the baseband circuit controls the RF switch to disconnect a reception path of the CDMA signal.

12. The dual mode mobile communication terminal as claimed in claim 11, wherein the RF switch processes and compresses non-linear signals from the LNA and separate the GSM signal and the CDMA signal, during transmission timeslot of the GSM signals, the baseband circuit controls the RF switch to disconnect a reception path of the CDMA signals and reduce the strength of the GSM signals entering into the LNA to reduce the interference between the GSM signal and the CDMA signal.

13. The dual mode mobile communication terminal as claimed in claim 12, wherein the baseband circuit comprises a GSM baseband microchip, the GSM baseband microchip is in electronic communication with the GSM RF circuit and the RF switch, the GSM baseband microchip decodes and converts the GSM signal from the GSM RF circuit into corresponding audio signal and further codes, compiles and synthesizes the audio signal into corresponding baseband signal to provide for the GSM RF circuit, and the GSM baseband microchip enables the LNA to adjust the gain of the LNA according to the power levels in the transmission of the GSM signals to further adjust the linearity of the LNA.

14. The dual mode mobile communication terminal as claimed in claim 13, wherein the baseband circuit further comprises a CDMA baseband microchip, the CDMA baseband microchip is in electronic communication with the GSM baseband microchip and the CDMA RF circuit, and the CDMA baseband microchip decodes and converts the CDMA signal from the CDMA RF circuit into corresponding audio signal, and further codes, compiles and converts the audio signals into corresponding baseband signals to the CDMA RF circuit.

15. The dual mode mobile communication terminal as claimed in claim 14, wherein the CDMA RF circuit further comprises a receiving filter electrically connected to the LNA, the receiving filter suppresses and filters out interference and noise to improve the quality of the CDMA signal.

16. The dual mode mobile communication terminal as claimed in claim 15, wherein the CDMA RF circuit further comprises a CDMA receiving unit electrically connected to the receiving filter and the CDMA baseband microchip, the CDMA receiving unit separates the desired CDMA signal from other signals, and demodulates the CDMA signal from the receiving filter, and transmits the demodulated CDMA signal to the CDMA baseband microchip to convert the demodulated CDMA signal into corresponding audio signal.

17. The dual mode mobile communication terminal as claimed in claim 14, wherein the CDMA RF circuit further comprises a CDMA transmitting circuit, and the CDMA transmitting circuit comprises a CDMA transmitting unit electrically connected to the CDMA baseband microchip, the CDMA transmitting unit is configured for modulating the baseband signal from the CDMA baseband microchip.

18. The dual mode mobile communication terminal as claimed in claim 17, wherein the CDMA transmitting circuit further comprises a transmitting filter electrically connected to the CDMA unit, the transmitting filter is capable of removing and filtering unwanted noise signals to suppress interfering signals and reduce background noise, and generate desired CDMA signals.

19. The dual mode mobile communication terminal as claimed in claim 18, wherein the CDMA transmitting circuit further comprises an amplifying circuit electrically connected to the transmitting filter and the CDMA antenna, the amplifying circuit is a RF power amplifier and is capable of amplifying the CDMA signal, and further transmitting its output CDMA signals to the CDMA antenna.
